(19) United States
(12) Patent Application Publication
(10) Pub. No.: US 2013/0188368 A1
(43) Pub. Date: Jul. 25, 2013

(54) OUTER SHELL APPARATUS FOR LIGHTING

(71) Applicant: Dafun Design Consultant Co., Ltd., Kaohsiung City (TW)

(72) Inventor: Yu-Ta CHEN, Kaohsiung City (TW)

(73) Assignee: DAFUN DESIGN CONSULTANT CO., LTD., Kaohsiung City (TW)

(21) Appl. No.: 13/739,005

(22) Filed: Jan. 11, 2013

(30) Foreign Application Priority Data
Jan. 20, 2012 (JP) 2012-241

(51) Int. Cl. F21V 15/01

(52) U.S. Cl. CPC F21V 15/01
USPC 362/362

(57) ABSTRACT

The present invention is related to an outer shell apparatus for lighting comprising an outer shell unit comprising a retaining base and a circumferential shell attached thereon; the circumferential shell comprising a shell body; the retaining base comprising a circumferencing slat for retaining a lighting element with an upward lighting therein; the circumferencing slat comprising a plurality of flexible retaining portions in a ring and spaced apart from each other to flex discretely; and a light reflecting and emitting unit provided on the outer shell unit and comprising a reflector and a light reflecting and emitting stand attached to the reflector inside the outer shell unit; wherein light emitted from the lighting element is reflected by the reflector and via said stand with an outward light diffusion such that the illumination area thereof is increased and the overall usability and applications of the lighting apparatus are improved.

### TECHNICAL FIELD OF THE INVENTION

The present invention is related to an outer shell apparatus, in particular, to an outer shell apparatus provided for a lighting element.

### Description of the Prior Art

As conventional lighting elements including such as flashlight and desktop lamps mostly provide illumination with lights emitted in a relatively concentrated and direct way, they are often being restricted to certain specific usages and applications of uses due to their localized and focused lighting characteristics.

For instance, in outdoor camping activities, flashlights hung inside tents can often be used as downlights in order to obtain certain desired lighting effect and illumination. However, as flashlights are of a relatively direct and focused lighting, the illumination area is much smaller and only localized lighting can be obtained. Such use of flashlights is not sufficient to obtain an adequate illumination covering the entire internal space of the tent in practice.

In view of the above drawbacks, the inventor provides a unique solution of an outer shell apparatus for a lighting element such that the illumination area obtained from such shell apparatus can be increased desirably to cover a sufficient area as the illumination of the lighting element is enhanced by the outer shell and such that the overall usability and applications can be improved.

### SUMMARY OF THE INVENTION

In view of the above, a primary objective of the present invention is to provide an outer shell apparatus for lighting capable of increasing the illumination area of a lighting element such that thee usability and practical applications thereof can be improved.

Accordingly, an outer shell apparatus for lighting of the present invention comprises an outer shell unit comprising a retaining base and a circumferential shell attached onto the retaining base; the circumferential shell comprising a shell body; the retaining base comprising a circumferencing slat for retaining a lighting element with an upward lighting therein; the circumferencing slat comprising a plurality of flexible retaining portions arranged in a ring and spaced apart from each other to flex discretely; and a light reflecting and emitting unit provided on the outer shell unit and comprising a reflector and a light reflecting and emitting stand attached to the reflector and provided inside the outer shell unit; and wherein light emitted from the lighting element is reflected by the reflector to different directions and via the light reflecting and emitting stand with an outward light diffusion such that the illumination area of the lighting element is increased and the overall usability and practical applications of the lighting apparatus are improved.

### BRIEF DESCRIPTION OF THE DRAWINGS

FIG. 1 is an exploded view of a first preferred embodiment of an outer shell apparatus for lighting of the present invention;

FIG. 2 is a cross sectional view of the assembly of the first preferred embodiment of the outer shell apparatus for lighting of the present invention with a lighting element being retained therein in a state of use;

FIG. 3 is a cross sectional view of the assembly of the first preferred embodiment of the outer shell apparatus for lighting of the present invention in a non-use sate for storage; and

FIG. 4 is a perspective view showing a second preferred embodiment of an outer shell apparatus for lighting of the present invention.

### DETAILED DESCRIPTION OF THE PREFERRED EMBODIMENTS

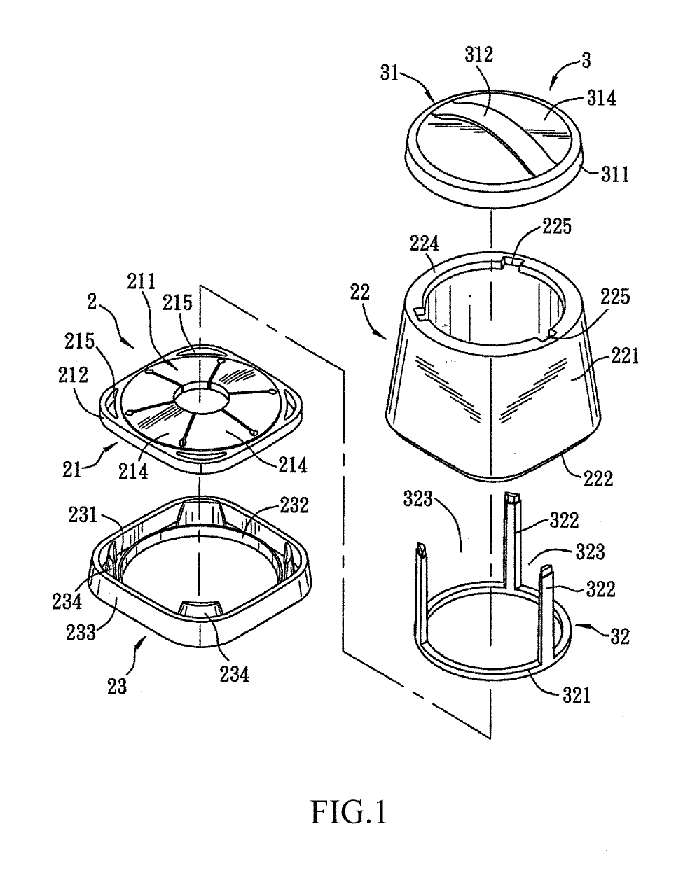

Please refer to FIG. 1 to FIG. 3, in which a first preferred embodiment of an outer shell apparatus for lighting of the present invention is illustrated. As shown in the figures, the outer shell for lighting of the present invention can be installed at the front of a lighting element 1 of a flashlight such that the lighting element 1 with an upward lighting can be hung at a high position to provide a desired illumination.

The outer shell apparatus for lighting for lighting of the present invention comprises an outer shell unit 2 and a light reflecting and emitting unit 3 attached to the outer shell unit 2 and configured to slide vertically therein in a relative manner.

The outer shell unit 2 comprises a retaining base 21, a circumferential shell 22 attached onto the retaining base 21 and a foundation base 23 for supporting the retaining base 21. The circumferential shell 22, the retaining base 21 and the foundation base 23 can be provided as discrete or separated parts or provided as one single integrally formed unit.

The retaining base 21 comprises a circumferencing slat 211, a circumferencing base 212 circumferencing an outer circumferential edge of the circumferencing slat 211 and having a shape of an inner circle with an outer square and a circumferential slot 213 provided on an outer circumferential side of a bottom surface of the circumferencing slat 211. The circumferencing slat 211 comprises six pieces of flexible retaining portions 214 arranged in a series to faun a ring and configured to flex up and down discretely. Each one of the flexible retaining portions 214 is generally of a shape of a delta. In this embodiment, the flexible retaining potions 214 and the circumferencing base 212 are made of silicon, rubber or plastics. In addition, the circumferencing base 212 comprises perforations 215 provided on four corners and spaced apart from each other at an equal angle. In this embodiment, the circumferencing base 212 and the circumferencing slat 211 are made of an identical material.

The circumferencing shell 22 comprises a shell body 221 having a shape of an inner circular and outer square, an attachment portion 222 extended from a bottom surface of the shell body 221 and attached to a top surface of the circumferencing base 212 of the retaining base 21 with an equal surface area, four insertion holes 223 penetrating through the attachment portions 222 and extended to an internal of the shell body 221 and a blocking ring 224 provided on a top surface of the shell body 221 and extended inward toward an axis thereof. In addition, an outer circumferential surface of the attachment portion 222 is tapered inward relatively without being aligned with an outer circumferential surface of the shell body 221. Furthermore, the aforementioned four insertion holes 223 are connected correspondingly to said four perforations of the retaining base 21 respectively; and the blocking ring 224 comprise three opening holes 225 spaced apart from each other at an equal angle.

The foundation base 23 comprises a circumferential base wall 231 having a shape of an inner circle and an outer square, a top abutting wall 232 extended upward from an inner circumferential edge of the circumferential base wall 231, an outer circumferential wall 233 extended upward from an outer circumferential edge of the circumferential base wall 231 and four insertion columns 234 spaced apart from each other and provided on the circumferential base wall 231. The circumferential base wall 231 is attached to the bottom surface of the circumferential base 212 of the retaining base 21 with an equal surface area. The top abutting wall 232 abuts the bottom surface of the circumferential slat 211 of the retaining base 21 and is inserted into the circumferential slot 213. The outer circumferential wall 233 surrounds the circumferential base 212 and the attachment portions 222 of the circumferential shell 22 and is attached to the bottom surface of the shell body 221. The aforementioned four insertion columns 234 penetrate through the four perforations 215 respectively and are further inserted into the four insertion holes 233 and adhered thereto with an adhesive.

The light reflecting and emitting unit 3 comprises a reflector 31 provided to be attached to a top of the circumferential shell 22 or to cover the circumferential shell 22 and configured to be hooked onto a third object and a light reflecting and emitting stand 32 configured to be extended upward by pulling out of the circumferential shell 22 or to be retracted downward into the circumferential shell 22. The reflector 31 comprises a reflecting body 311 and a hook 312 for external securement. The reflecting body comprises a reflecting surface 313 facing downward and a top surface 314 facing upward and attached to the hook 312. In this embodiment, the reflecting surface 313 is generally of a cone shape but is not limited to such shape. The light reflecting and emitting stand 32 comprises a restricting ring 321 provided inside the shell body 221 of the circumferential shell 22 and configured to slide vertically therein and to be blocked by the blocking ring 224 to prevent sliding off the shell body 221, three sliding columns 322 spaced apart from each other and provided between the reflector 31 and the restricting ring 321 to be inserted into the aforementioned three opening holes 225 respectively and three hollow type of light transmissive zones 323 defined and provided by the three sliding columns 322.

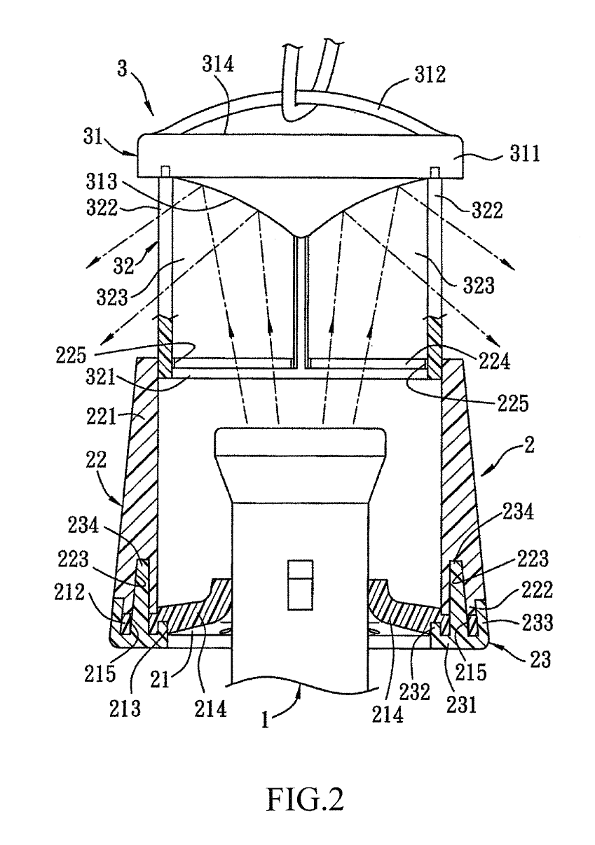

As shown in FIG. 2, during the usage of the outer shell for lighting of the present invention, the lighting element 1, for example such as a flashlight, is inserted into the circumferential slat 211 in such a way that the light shone to the above with an upward lighting. As the grip portion of the lighting element 1 is of an outer diameter generally greater than the inner diameter of the circumferential slat 211, the six flexible retaining portions 214 are then forced by the lighting element 1 to flex upward and arched in deformation such that the six flexible retaining portions 214 are able to exert a retaining force and effect onto the lighting element 1. In addition, with the attachment portion 222 and the top abutting wall 231, the outer circumferential side of the circumferential slat 211 is being suppressed such that the flexible retaining force exerted onto the lighting element 1 by the six flexible retaining portions 214 is further enhanced and such that the lighting element 1 can be firmly secured in position within the circumferential shell 22. Furthermore, the light reflecting and emitting element 3 can be pulled upward and out of the circumferential shell 22 while the hook 312 of the reflector 31 can be secured at any predetermined position by ways of such as hanging.

Accordingly, the light emitted by the lighting element 1 in an upward direction can be reflected by the reflector 31 to be further diffused via the aforementioned three light transmissive zones 323 outward; and as a result, the illumination obtained from the lighting element 1 in cooperation with the outer shell for light of the present invention can be of a soft and uniform lighting with greater illumination area that is not limited to a localized illumination for suitable applications. In addition, the lighting element 1 can now be used to satisfy the needs of greater illumination area and the overall usability and practical application of the lighting element 1 can also be improved.

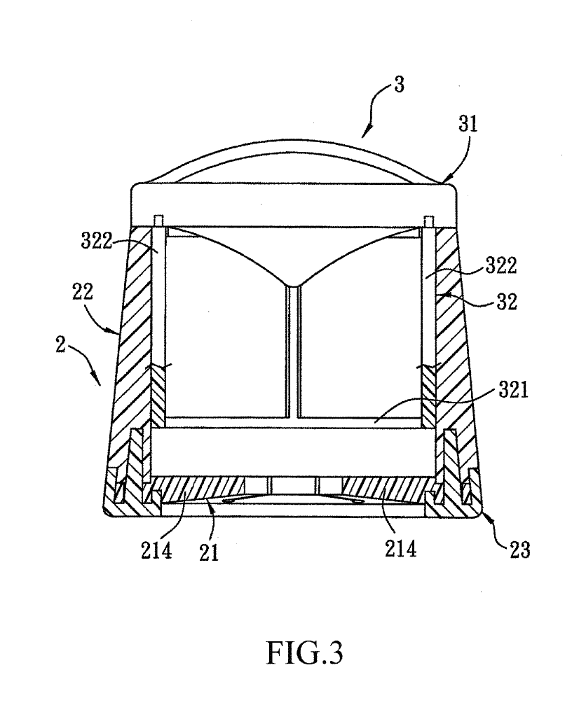

In view of the above, it can be understood that the outer shell for lighting of the present invention is not only convenient to use but also with greater advantages in practical applications. In addition, as shown in FIG. 3, during its non-usage, it can be stored by retracting the light reflecting and emitting stand 32 downward in a vertical direction into the circumferential shell 22 such that the overall size of the outer shell for lighting of the present invention can be greatly reduced for improved portability and storage capability.

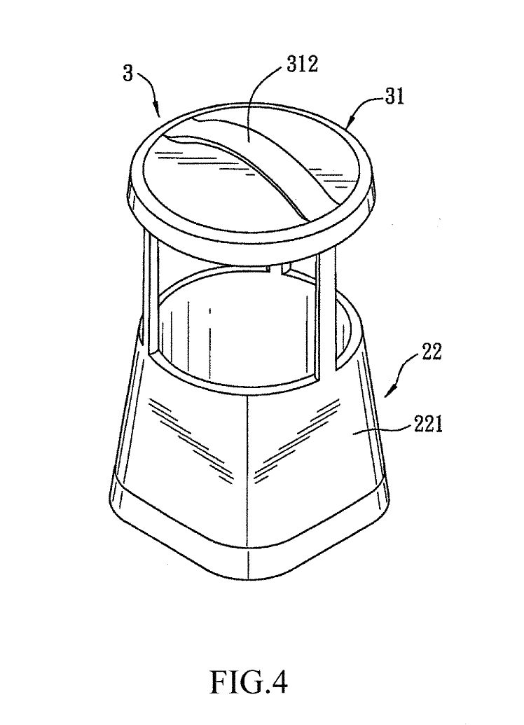

FIG. 4 shows a second preferred embodiment of an outer shell apparatus for lighting of the present invention, which varies from the aforementioned first preferred embodiment mainly in that the light reflecting and emitting unit 3 is entirely attached to the top of the shell body 221 of the circumferential shell 22 firmly. Therefore, it can be understood that the restricting ring 321, the blocking ring 224 of the circumferential shell 22 of the light reflecting and emitting unit 3 in the related parts shown in FIG. 1 can be omitted. Furthermore, it too can be understood that the hook 312 of the reflector 31 of the light reflecting and emitting unit 3 can also be considered to be a non-essential component in this embodiment.

During its usage, the lighting element 1, such as a flashlight (not shown in the figure), with an upward lighting can be position on a desktop surface, following which the outer shell for lighting of the present invention can be installed at the top of the lighting element 1 such that an illumination similar to the one of a desktop lamp can too be advantageously achieved.

What is claimed is:

1. An outer shell apparatus for lighting:
an outer shell unit comprising a retaining base and a circumferential shell attached onto said retaining base; said circumferential shell comprising a shell body; said retaining base comprising a circumferencing slat for retaining a lighting element with an upward lighting therein; said circumferencing slat comprising a plurality of flexible retaining portions arranged in a ring and spaced apart from each other to flex discretely;
a light reflecting and emitting unit provided on said outer shell unit and comprising a reflector and a light reflecting and emitting stand attached to said reflector and provided inside said outer shell unit; and wherein light emitted from said lighting element is reflected by said reflector and via said light reflecting and emitting stand with an outward light diffusion.

2. The outer shell apparatus for lighting according to claim 1, wherein said retaining base of said outer shell unit further comprises a circumferencing base circumferencing an outer circumferential edge of said circumferencing slat and attached to said circumferential shell.

3. The outer shell apparatus for lighting according to claim 1, wherein said light reflecting and emitting stand of said light reflecting and emitting unit comprises a restricting ring provided on said outer shell unit and configured to slide vertically therein in a relative manner and a plurality of sliding columns spaced apart from each other and each having two opposite ends attached to said restricting ring and said reflector respectively; and wherein a light transmissive zone is defined and provided between two of said sliding columns adjacent to each other.

4. The outer shell apparatus for lighting according to claim 1, wherein said reflector of said light emitting and reflecting unit comprises a reflecting body attached to said light emitting and reflecting unit and a hook; and
wherein said reflecting body comprises a reflecting surface facing downward and a top surface facing upward and attached to said hook.
